(19) United States
(12) Patent Application Publication
(10) Pub. No.: US 2005/0044225 A1
(43) Pub. Date: Feb. 24, 2005

(54) Network system, appliance controlling household server, and intermediary server

(75) Inventors: Seiya Ota, Ama-gun (JP); Kazuya Ogawa, Mizuho-City (JP); Yoshinori Hatayama, Komaki City (JP); Hiroshi Takemura, Ama-Gun (JP); Yoshihiro Hori, Gifu-City (JP); Etsuko Sugimoto, Tokyo-to (JP); Toshiaki Hioki, Ogaki City (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 10/900,091

(22) Filed: Jul. 28, 2004

(30) Foreign Application Priority Data
Aug. 5, 2003 (JP) 2003-287235 (P)

(51) Int. Cl. G06F 15/16; G06F 15/173

(52) U.S. Cl. 709/225; 709/223; 709/227; 709/208

(57) ABSTRACT

Provided is a network system which is capable of smooth remote control of appliances in a household while improving the security. A household server for controlling home appliances and an external server for mediating between the household server and a user terminal are set on an Internet. The household server gives a right to access only to the external server that is registered in advance. When accessed by the user terminal, the external server performs user authentication and, if the access is authenticated as from an authorized user, specifies which household server is to be used by the user, and makes an access request to the corresponding server. The household server checks whether the access request is valid or not and, when the access request is found as a result to be valid, allows the user terminal to input a control instruction through the intermediation of the external server.

### BACKGROUND OF THE INVENTION

1. Field of the Invention

The present invention relates to a network system for remotely controlling appliances in a household by utilizing a network such as the Internet.

2. Description of the Related Art

With development of networks, a typical example of which is the Internet, demand is increasing for the ability to control appliances in one's house while away from home by connecting the appliances to a home network. One of the answers to the demand that have been proposed is a system with a server device set up in a household to receive access from the outside and to enable one who directly accesses this server device to control appliances in the household remotely.

However, this type of network systems inevitably expose the household server device to access from external unspecified parties since the systems allow the household server device to receive access from the outside. The systems are accordingly vulnerable to stealing and tampering of electronic data on the network, impersonators who take control of the appliances in the household without authorization, and other similar problems.

### SUMMARY OF THE INVENTION

The present invention has been made to solve the above-mentioned problems, and an object of the present invention is to provide a network system capable of smooth remote control of appliances in a household while improving the security.

The present invention relates to a system which includes a server for controlling appliances in a household and an intermediary server for mediating between the server and a user terminal, and which only allows an intermediary server that is registered in advance a right to access the appliance controlling household server. The intermediary server here performs user authentication upon receiving access from a user terminal and, when the access is verified as from an authorized user, specifies an appliance controlling household server that is to be used by the user, and makes a request to access the specified server on behalf of the user terminal. The appliance controlling household server determines whether the access request is valid or not and, when it is judged as a result that the access request is valid, allows the user terminal to input a control instruction through the intermediary server.

Major characteristics of the present invention are as follows.

A network system according to a first aspect of the present invention, includes:
a first server for controlling appliances in a household; and
a second server allowed to access the first server, the first server including:
   a first authentication means for authenticating an access source; and
   appliance controlling means for controlling a control target appliance in accordance with control information received from the second server,
the second server including:
   a second authentication means for authenticating the access source;
   access target specifying means for specifying which first server is to be used by a user as the access source;
   access request means for sending an access request to the specified first server;
   control information creating means for creating control information based on a control instruction which is received from a user terminal; and
   transmission means for sending the created control information to the first server that is the access target.

According to the present invention, the second server alone is allowed to access the appliance controlling household first server and therefore the first server is protected against general public access. In addition, the double verifying of an access source in which the second server and the first server separately verify the legitimacy of the access blocks unauthorized access from a third party who impersonates an authentic user. The present invention thus makes it possible to effectively avoid such problems as stealing and tampering of data on the network and those who attempt to take control of the appliances in the household without authorization.

The present invention may be structured such that position information (IP address or the like) of the second server that has the right to access is registered to the first server in advance enabling the first server to authenticate an access request made by the second server by checking whether the position information of the access source matches the pre-registered position information or not. In this way, whether the access source has a right to access or not can be checked smoothly and efficiently.

The present invention may also be structured such that a user or users who are allowed to control appliances in the household are registered in a database of the first server in advance enabling the first server to test the authenticity of an access source mediated by the second server by checking whether user identification information sent from the second server is listed in the user database or not. In this way, whether the access source has a right to access or not can be checked more accurately.

The present invention may also be structured such that a rule database storing stylized rule patterns, which regulate rules in controlling appliances, is provided in the first server enabling the first server to pick up from the rule database a rule pattern that conforms to rule pattern specifying information contained in control information that is received from the second server, and to control a target appliance in accordance with the rule pattern specified. This allows smooth transfer of control information from the second server to the first server. In addition, when provided with control information that conforms to none of the rules in the rule database, the first server does not implement control operation and thus the present invention can more thoroughly exclude access that attempts to take control over appliances in the household without authorization.

The present invention may also be structured such that a database in which identification information of a user is stored and associated with position information of the first server to be used by the user is provided in the second server enabling the second server to authenticating an access source by checking whether user identification information received from a user terminal is listed in the database or not and, when an access source is authenticated, to extract from the database the position information of the first server that is associated with the user identification information. User authentication and specifying a first server are thus associated with each other in the second server. In this way, a user cannot access any first server but the one assigned to him/her and, even if other users manage to access the second server, the second server does not allow them to access the first server in question. Therefore the present invention can more thoroughly exclude access that attempts to take control over appliances in the household without authorization.

The present invention may also be structured such that information in which position information of the first server is encrypted is used as user identification information. In this way, user authentication and specifying a first server can be associated more closely with each other in the second server, and the present invention can more thoroughly exclude access that attempts to take control over appliances in the household without authorization.

The present invention may also be deemed as a server that constitutes a network system in the above-described first aspect of the invention.

### BRIEF DESCRIPTION OF THE DRAWINGS

The aforementioned and other objects, and novel characteristics of the present invention will more completely be understood from the following detailed description of embodiments when taken in conjunction with the accompanying drawings in which:

FIG. 1 shows the configuration of a network system according to a mode of carrying out the present invention;

FIG. 2 is a function block diagram of a household server 100 according to Embodiment 1 of the present invention;

FIGS. 3A and 3B show the data configuration of a device DB 108 and a user DB 109 of the household server 100;

FIGS. 4A and 4B show the data configuration of a rule DB 110 and an execution rule DB 111 of the household server 100;

FIG. 5 is a function block diagram of an external server 200;

FIGS. 6A and 6B show the data configuration of an intellectual DB 206 of the external server 200;

FIGS. 7A and 7B show the data configuration of the intellectual DB 206 of the external server 200;

FIG. 8 shows the data configuration of a user DB 209 of the external server 200;

FIG. 9 shows a processing flow of a network system according to Embodiment 1;

FIG. 10 shows a processing flow in Step S113 of the above processing flow;

FIG. 11 shows a processing flow in Step S113 of the above processing flow;

FIG. 12 shows a processing flow in Step S203 of the above processing flow;

FIG. 13 is a function block diagram of a household server 100 according to Embodiment 2 of the present invention;

FIG. 14 shows a processing flow of a network system according to Embodiment 2 of the present invention; and

FIG. 15 shows a processing flow of a network system according to Embodiment 3 of the present invention.

### DETAILED DESCRIPTION OF THE PREFERRED EMBODIMENTS

A mode of carrying out the present invention is described below with reference to the accompanying drawings. It should be noted that the following embodiment mode is merely an example of the present invention and is not to limit the scope of the present invention.

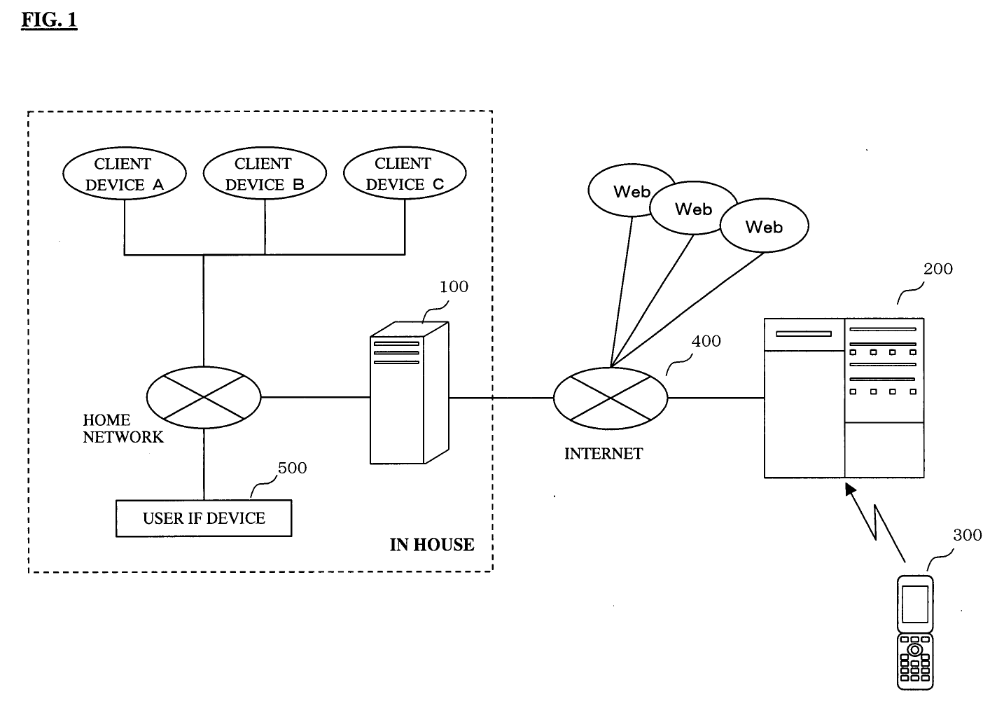

FIG. 1 shows the configuration of a network system according to this embodiment mode.

The network system is composed of: a household server 100 installed in a house; an external server 200 set up outside of the house; a user terminal 300 accessible to the external server 200; an Internet 400 for connecting the household server 100 and the external server 200 to each other; and a user interface (IF) device 500 for inputting information to the household server 100.

The household server 100 has transmitting/receiving means compliant to communication protocols such as ECHONET, UPnP, and SCP, and can be connected to client devices including an air conditioner and a DVD recorder through household communication means such as a power supply line. When a control instruction is inputted by a user, the household server 100 creates a control command in accordance with the control instruction and sends the control command to a client device that is to be controlled through the household communication means.

A user in his/her home inputs a control instruction to the household server 100 through the user IF device 500. Away from home, the user inputs a control instruction to the household server 100 through the intermediation of the external server 200. The only server in the system that can accessed to the household server from the point outside of the house when he/she is not home is the external server 200 that is registered in advance. Specifically, when IP protocol is employed as the communication protocol, the household server 100 receives only access that is sent from the IP address of the relevant external server 200 and denies access from any other IP address. By limiting access sources in this manner, unauthorized access to the household server 100 can be blocked and client devices can be prevented from being controlled by an unauthorized party.

The external server 200 checks for authentication purpose whether access from the user terminal 300 is made by an authorized user or not. Specifically, upon receiving an access request, the external server 200 judges whether or not first identification information (family ID) received from the user terminal 300 along with the access request has already been registered in its own user database (DB). When the family ID is found to be listed in the user DB, the external server 200 allows the access whereas the access is denied when the family ID is not listed in the user DB.

This system uses, in addition to the first identification information (family ID), second identification information (user ID) as identification information for user authentication. Only one family ID is given to one household server. On the other hand, user ID is set individually for each user that uses the household server. The user terminal 300 provides family ID and user ID to the external server 200.

Family ID and user ID may be provided as soon as the user terminal 300 accesses the external server 200, or may be provided separately as the external server 200 makes a transmission request to the user terminal 300. A user may directly input his/her family ID and user ID to the user terminal 300, or the IDs may be retrieved from a memory in the user terminal 300.

The provided family ID is used in user authentication performed by the external server 200 as described above. The provided user ID is used in user authentication performed by the household server 100 after the authentication by the external server 200. To elaborate, when user authentication performed by the external server 200 proves that it is access from an authorized user, the external server 200 sends the user ID provided from the user terminal 300 to the household server 100 to request access to the household server 100. Receiving the request, the household server 100 judges whether or not the received user ID has already been registered in its own user database (DB). The household server 100 allows the access from the external server 200 in the case where the received user ID is listed in the user DB whereas the access from the external server 200 is denied in the case where the user ID is not found in the user DB.

When the access is allowed by the household server 100, the user can now input a control instruction to the household server 100 through the intermediation of the external server 200. The user inputs a control instruction to the user terminal 300, which sends the control instruction to the external server 200. In inputting a control instruction, various information communication media including voice and electronic mail are available to the user. For instance, in the case where the user terminal 300 is a cellular phone, the user can input a voice message “Recording the Game of Giants versus Tigers”. This audio information is sent from the user terminal 300 to the external server 200.

The external server 200 interprets the received audio information and creates control information for controlling the target appliance in the household. Specifically, upon receiving the audio information “Recording the Game of Giants versus Tigers”, the external server 200 recognizes voice and creates control information for recording the corresponding program in a recorder device. The created control information is sent to the household server 100, which then creates from the received control information a control command for controlling the target appliance and sends the control command to the target appliance. In this example, the control command for programmed recording of the Giants-Tigers game is sent to a recorder (e.g., a DVD recorder) in the household. This completes setting up programmed recording from the outside of the house.

The external server 200 has an intellectual database to interpret a control instruction inputted from the user terminal 300 and create control information from the instruction. The intellectual database stores variety of data necessary for intellectual processing. For instance, the intellectual database stores a table in which keywords needed to specify the “function category” of a target appliance are associated with categories. When the function category of a target appliance is “recording”, keywords associated with the category are “recording”, “record-keeping”, “programmed recording”, and the like. In the above example, as the user inputs the voice message “Recording the game of Giants versus Tigers”, the table is looked up for the word “recording” in the audio(voice) information and the function category of the control target appliance is specified as the “recording” function.

Once the function category of the control target appliance is specified in this way, the external server 200 inquires of the household server 100 what appliances are in the household that fall within the “recording” function category. The household server 100 selects client devices that fall within the “recording” function category (for example, a DVD recorder or a VCR) out of the controllable client devices in the household and sends the chosen ones as candidates to the external server 200. The external server 200 provides the user terminal 300 with the candidate client devices received from the household server 100. The user chooses a desired control target appliance (e.g., the DVD recorder) out of the presented candidates, and the choice is sent to the external server 200. The control target appliance is thus specified.

Instead of the above target appliance specifying processing in which the external server 200 inquiries of the household server 100 what appliances in the household fall within the function category in question, the external server 200 may specify appliances that fall within the function category by itself. In this case, for instance, the external server 200 obtains information that shows association between client devices with function categories from the household server 100 during the above-described confirmation of access to the household server 100, so that the external server 200 can specify client devices that correspond to the function category derived from the control instruction. Alternatively, a database of client devices and their function categories is built in advance for each household server in the external server 200 to enable the external server 200 to specify client devices that correspond to the function category derived from the control instruction.

The intellectual database also stores a table in which “control condition” categories (temperature, time, humidity, and the like) are associated with keywords necessary to specify parameters of the categories. For instance, keywords such as “xx degrees (centigrade)” are associated with the “temperature” control condition category where as key words such as “xx hour” and “xx minute” are associated with the “time” control condition category.

Also stored in the intellectual database is a table in which “control action” categories (channel, air conditioners setting mode, and the like) are associated with keywords necessary to specify parameters of these categories. For instance, keywords such as “Channel X” are associated with the “channel” control action category. For the “air conditioners setting mode”, keywords such as “cooler” and “cooling” are associated with the “cooling mode” category whereas keywords such as “heater” and “heating” are associated with the “heating mode” category.

Another table stored in the intellectual database contains keywords showing triggers of “control actions”. For instance, keywords such as “ON”, “start” and “record” are associated with the trigger “ON” of a control action whereas keywords such as “end” and “stop” are associated with the trigger “OFF” of a control action.

An input of a control instruction from an authorized user starts a comparison between keywords in the control instruction and keywords in the intellectual database to specify a “control condition” category and its parameter, a “control action” category and its parameter, and a trigger of the “control action”. For instance, when the user inputs an instruction saying “record Channel 10 from 8 o'clock”, the inputted instruction is segmented into “8 o'clock”, “Channel 10” and “record”. Then the external server 200 consults the intellectual database to specify the control condition category as “time” and its parameter as “8 o'clock”, the control action category as “channel” and its parameter as “10 ch”, the function category as “recording”, and the control action trigger as “ON”.

The intellectual database stores other information necessary to specify the “control condition” and “control action” categories and parameters of the categories. For instance, the intellectual database has a timetable for broadcast programs for each region as information necessary to specify the “control condition” category, the “control action” category, and their parameters for programmed recording. The external server 200 accesses a site that provides a local broadcast program schedule as needed and obtains the latest Electronic Program Guide (EPG). The obtained EPG is segmented into keywords to build a database of broadcast program timetables for regions in the intellectual database.

In the above example where the user inputs the instruction “Recording the game of Giants versus Tigers”, a program that is broadcasted earliest following the input of the instruction, and contains the keywords “the game of Giants versus Tigers”, “Giants”, “Tigers”, “game” and “versus” all is picked out of the broadcast program timetable of the region where the user resides. Then the channel of the specified program (10 ch, for example) and the start and finish time of the program (19:00 to 21:00, for example) are extracted from the broadcast program timetable and set as parameters of the control action and of the control condition.

Once the “function category”, “target appliance”, “control condition”, “control action” and “start/finish trigger” are thus specified by consulting the intellectual database, the external server 200 creates control information from the items specified and sends the control information to the household server 100. The household server 100 creates a control command from the received control information and sends the control command to the control target appliance, thereby implementing control of the control target appliance.

To add to the outline of this embodiment mode given in the above, certain control rules are set in the household server 100 and the external server 200 for smooth transfer of control information from the external server 200 to the household server 100 and subsequent execution of a control command. Details of the control rules will be described in Embodiments below.

<<Embodiment 1>>

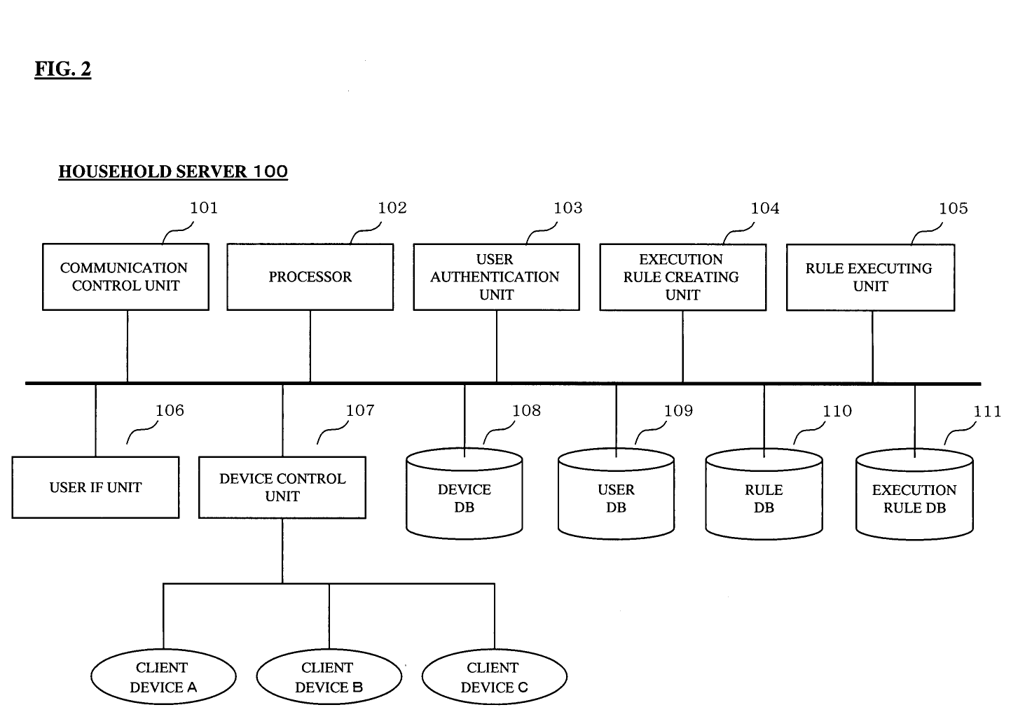

FIG. 2 is a block diagram of the household server 100.

As shown in FIG. 2, the household server 100 is composed of a communication control unit 101, a processor 102, a user authentication unit 103, an execution rule creating unit 104, a rule executing unit 105, a user interface (IF) unit 106, a device control unit 107, a device DB 108, a user DB 109, a rule DB 110, and an execution rule DB 111.

The control communication unit 101 controls data communications through the Internet 400. The processor 102 controls each unit in accordance with the relevant processing program. The processor 102 also executes processing for allowing only access from the authorized external server 200. This processing implemented by the processor 102 is to receive only access from the IP address of the external server 200 that has the right to access while denying access from any other IP address. The IP address of the external server that has the right to access is stored in a not-shown, built-in memory. Upon receiving an access request from the external, the processor 102 compares the IP address of the access source with the IP address stored in the built-in memory and allows the access request only when the two addresses match.

The user authentication unit 103 checks whether or not the user ID and password obtained upon an access request made by the external server 200 are listed in the user DB 109 to decide if the access request from the external server 200 is acceptable.

The execution rule creating unit 104 creates execution rules based on control information received from the external server 200, and registers the rules in the execution rule DB 111. Details of the function of the execution rule creating unit 104 will be described later. The rule executing unit 105 monitors execution rules (control conditions) registered in the execution rule DB 111 and judges whether or not control conditions for a control target client device are met. When the control conditions are met, the rule executing unit 105 sends control information to the device control unit 107. Details of the function of the rule executing unit 105 will be described later.

The user IF unit 106 sends, to the processor 102, input information inputted from the user IF device 500. The device control unit 107 creates a control command according to the control information received from the rule executing unit 105, and sends the control command to a client device that is the control target.

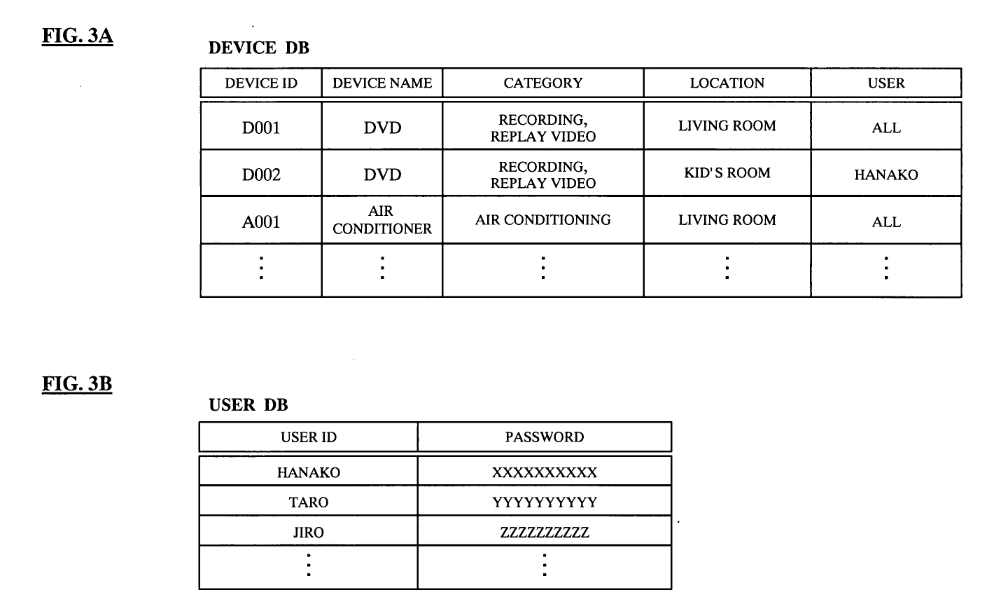

The device DB 108 is a database for storing data related to client devices controllable by the device control unit 107. FIG. 3A shows the configuration of data stored in the device DB 108. As shown in FIG. 3A, the device DB 108 stores, for each client device, device ID for specifying the client device in question, the device name of the client device, the function category of the client device, location data indicating where the client device is installed, and user ID for specifying a user that has a right to control the client device.

Returning to FIG. 2, the user DB 109 is a database in which users who have the right to access the household server 100 are registered. FIG. 3B shows the configuration of data stored in the user DB 109. As shown in FIG. 3B, the user DB 109 stores, for each user, the user ID and password of the user in question.

Returning to FIG. 2, the rule DB 110 is a database for storing stylized rules (skeleton rules) in which possible control methods of the respective function categories are each segmented into event, control condition (condition), and control action (action).

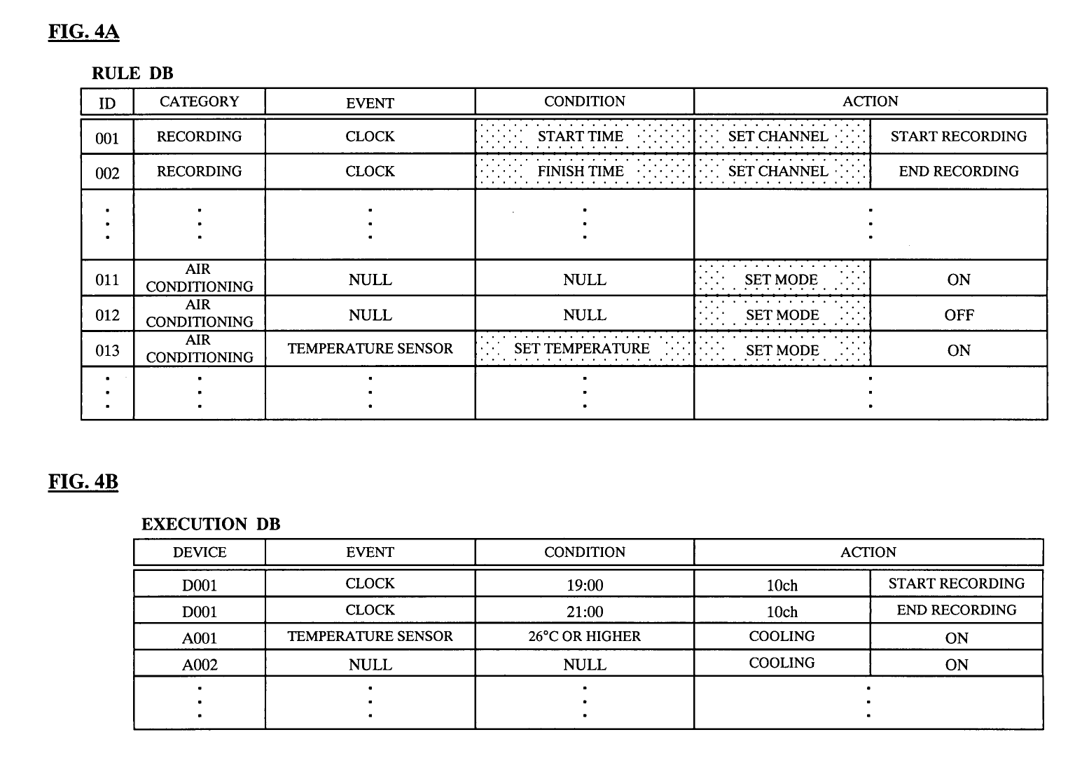

FIG. 4A shows the configuration of data stored in the rule DB 110. As shown in FIG. 4, the rule DB 110 stores, for each rule, the rule ID for specifying the rule in question, the function category to which the rule is applied, the event the rule consults, the control condition (condition) of the rule, and the control action (action) of the rule.

For instance, the rule of which rule ID is 001 is about programmed recording and, when the event “clock” has reached the condition “start time”, the action “start recording” “set channel” is carried out. To give another example, the rule of which rule ID is 013 is about air conditioning setting and, when the event “temperature” has reached the condition “set temperature”, the action “set mode (cooling, heating, dehumidification, fanning)” “ON” is carried out. Note that some rules have neither event nor condition. For instance, the event and condition columns in the rule of rule ID 011, which is about air conditioning setting, both the event and the condition bear the word NULL. In this rule, the action alone can be set by a control instruction and the rule is used when the control instruction inputted instructs to merely turn the “set mode (cooling, heating, dehumidifying, fanning)” “ON”.

Note that the hatched cells in FIG. 4A are cells in which parameters are put upon creation of execution rules. How parameters are put in those cells will be described later.

Returning to FIG. 2, the execution rule DB 111 is a database for registering execution rules which are created by the execution rule creating unit 104. FIG. 4B shows the configuration of data stored in the execution rule DB 111. As shown in FIG. 4B, the execution rule DB 111 stores, for each execution rule, device ID for specifying a client device that is the control target, an event consulted to monitor how a control condition is fulfilled, the control condition (condition) for this control, and a control action (action) for this control.

For instance, the execution rule in the topmost row of FIG. 4B is for setting programmed recording (the start of recording) in a device D001 and, when the event “clock” reaches the condition “19:00”, the action “start recording” “Channel 10” is carried out. To give another example, the execution rule in the third row from the top is for setting cooling and, when the event “temperature” reaches the condition “26° C. or higher”, the action “cooling” “ON” is carried out. Some of execution rules registered in the execution rule DB 111 have the word “NULL” in their event and condition columns as shown in the fourth row from the top of FIG. 4B. In such execution rules, the control is implemented immediately without setting conditions.

The execution rule creating unit 104 creates an execution rule by obtaining from, for example, the external server 200, a rule ID, a device ID, a condition parameter, and an action parameter. To elaborate, the execution rule creating unit 104 puts the obtained condition parameter and action parameter in a rule specified by the obtained rule ID and adds the obtained device ID to create an execution rule. For instance, when rule ID=001, device ID=D001, condition parameter=19:00, and action parameter=10 ch are obtained, the rule that has the rule ID 001 is selected from rules in FIG. 4A to put the condition parameter “19:00” and the action parameter “10 ch” in, and the device ID “D001” is added thereto, thus creating the execution rule in the topmost row of FIG. 4B.

The rule executing unit 105 monitors an execution rule registered in the execution rule DB 111 to judge whether the condition of the execution rule in question is fulfilled. In the case of the execution rule in the topmost row of FIG. 4B, for instance, the rule executing unit 105 judges whether the current time is 19:00 or not from time information provided by a clock. When the current time is 19:00, the rule executing unit 105 sends control information composed of device ID=D001 and action=10 ch +“start recording” to the device control unit 107, which creates from the control information received a control command. The control command is sent to the client device specified by the device ID “D001”.

Note that when an execution rule having “NULL” as its control condition is registered in the execution rule DB 111, the rule executing unit 105 immediately creates control information (device ID+action) from the execution rule and sends the control information to the device control unit 107. An execution rule having “NULL” as its control condition is therefore implemented as soon as registered in the execution rule DB 111, and the control target client device is controlled immediately.

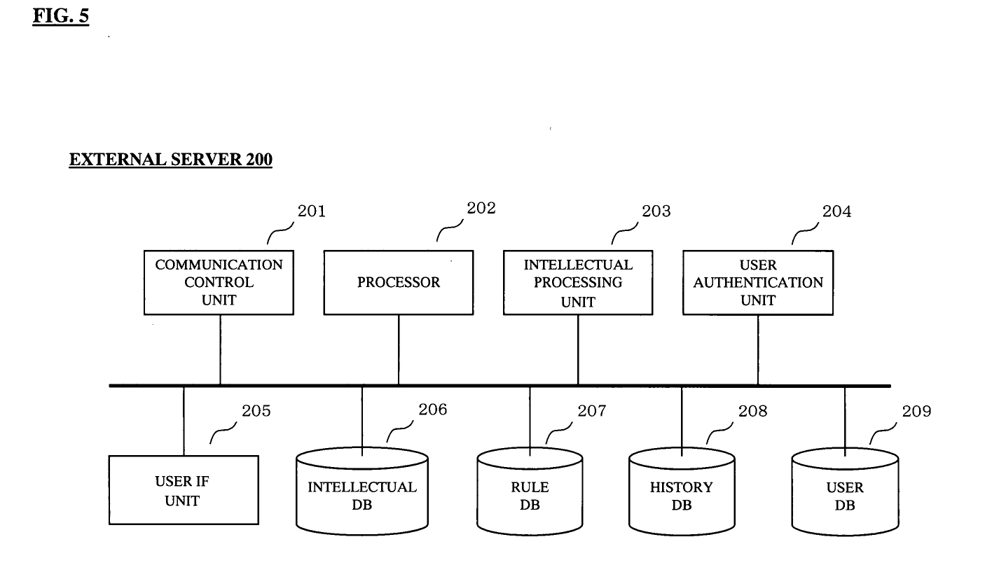

FIG. 5 is a function block diagram of the external server 200.

As shown in FIG. 5, the external server 200 is composed of a communication control unit 201, a processor 202, an intellectual processing unit 203, a user authentication unit 204, a user interface (IF) unit 205, an intellectual DB 206, a rule DB 207, a history DB 208, and a user DB 209.

The communication control unit 201 controls data communications through the Internet 400 or through a telephone communication network. The processor 202 controls each unit in accordance with the relevant processing program. The intellectual processing unit 203 consults the intellectual DB 207 to interpret a control instruction from a user, and creates control information. Details of the function of the intellectual processing unit 203 will be described later. The user authentication unit 204 checks whether family ID and password obtained upon an access request made by the user terminal 300 are listed in the user DB 209 to decide if the access request from the user terminal 300 is acceptable. The user IF unit 205 converts a control instruction (voice, e-mail, and others) inputted from the user terminal 300 into text data and sends the text data to the intellectual processing unit 203.

The intellectual DB 206 is a database for storing variety of data necessary for the intellectual processing unit 203 to interpret a control instruction and create control information. The intellectual DB 206 corresponds to the intellectual database that has been described above in the outline of the embodiment mode. The following databases are built in the intellectual DB 206:
1) a table of keywords necessary to specify “function categories”;
2) a table of keywords necessary to specify “control condition” categories (temperature, time, humidity, and the like) and their parameters;
3) a table of keywords necessary to specify “control action” categories (channel, air conditioners setting mode, and the like) and their parameters;
4) a table of keywords indicating triggers of “control actions”; and
5) other information necessary to specify “control condition” categories, “control action” categories, and their parameters (a broadcast program timetable database and the like).

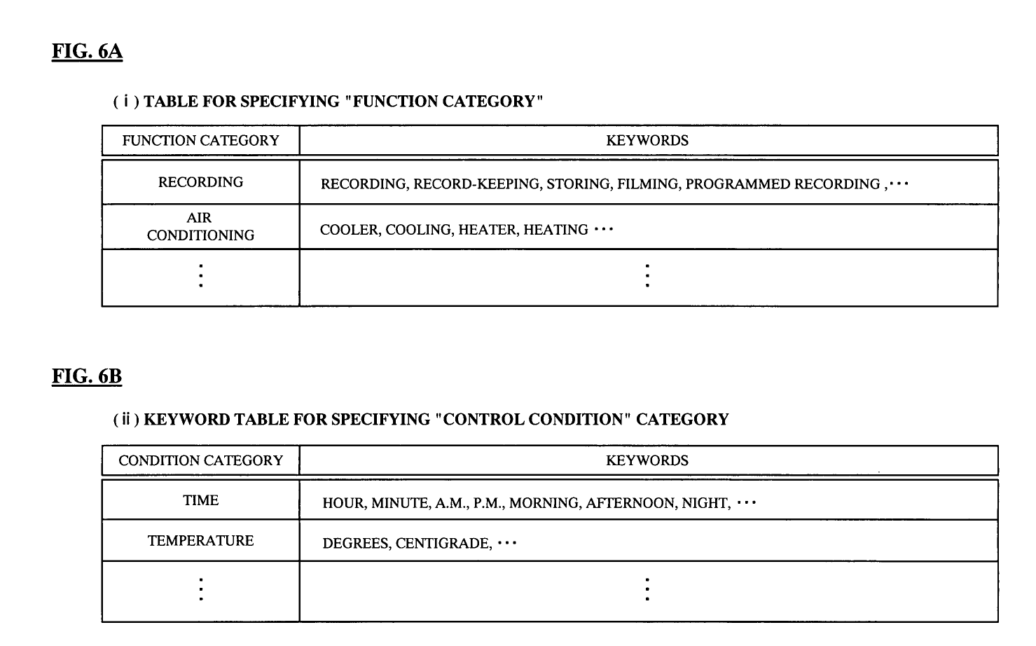

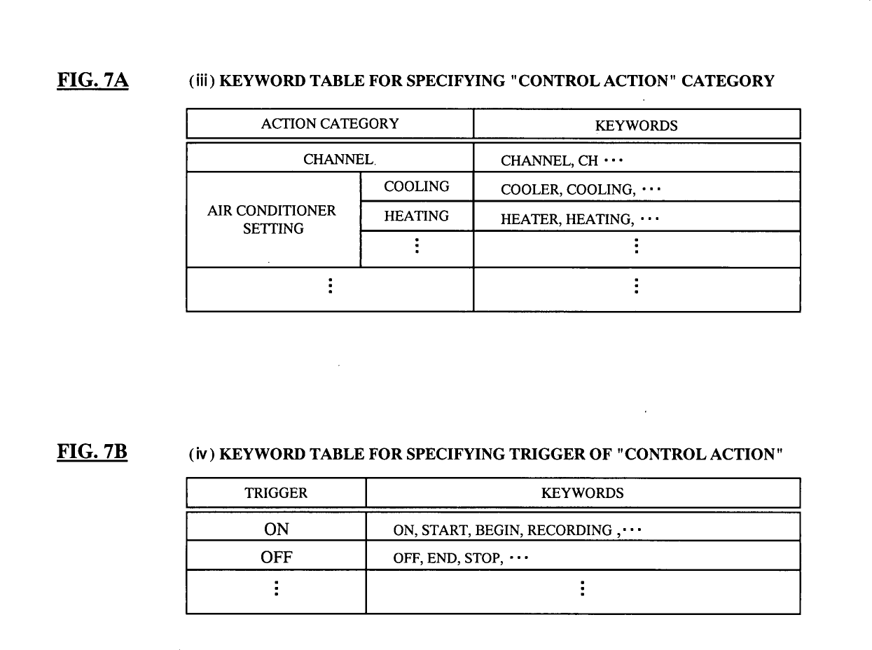

FIGS. 6A and 6B and FIGS. 7A and 7B show the data configuration of the tables 1) through 4) stored in the intellectual DB 206. In addition to the data given in the above, the intellectual DB 206 stores information necessary to interpret an instruction inputted by a user (for example, a table necessary to specify where a control target appliance is installed (location)), a language database necessary for language processing of a control instruction given by a user, a language processing program, and others.

Returning to FIG. 5, the rule DB 207 stores data similar to the one stored in the rule DB 110 of the household server 100, namely, skeleton rule. The history DB 208 stores, for each user, the history of control information sent to the household server 100.

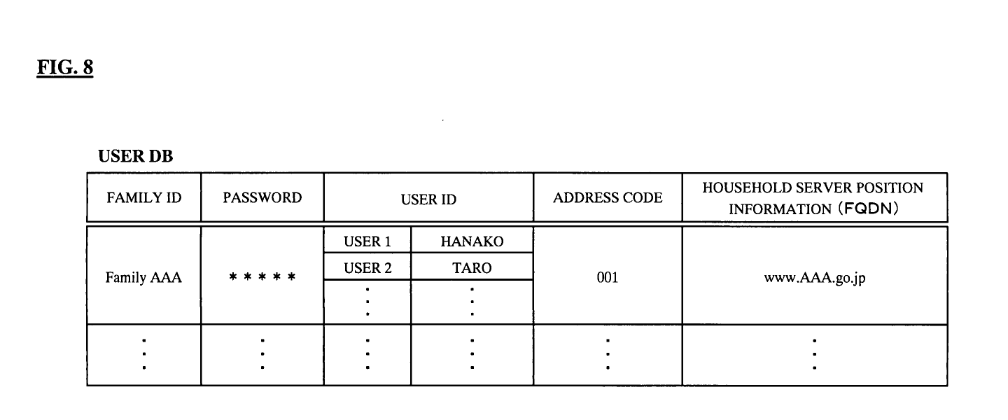

The user DB 209 is a database for registering users that have the right to access the external server 200. FIG. 8 shows the configuration of data stored in the user dB 209. As shown in FIG. 8, the user DB 209 stores, for each family ID, the password of the family ID in question, the user ID of every user that can use this family ID, the address code of the user's residence, and the position information (FQDN) of the household server for which the family ID is set.

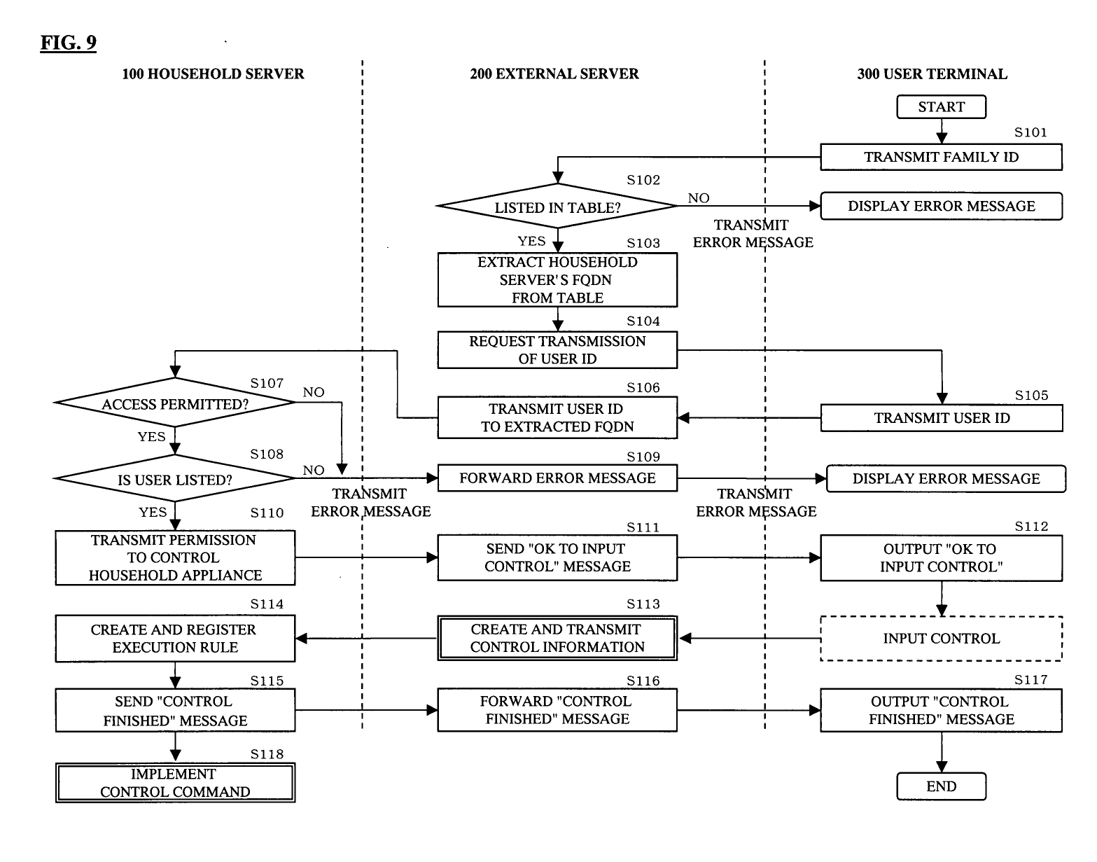

Described next with reference to FIG. 9 is the operation of the system according to this embodiment.

The user terminal 300 makes a control instruction input request to the external server 200. Upon receiving the input request, the external server 200 demands the user terminal 300 to input the family password. When the user inputs his/her family password as demanded, the user terminal 300 sends the inputted family password and the family ID stored in advance in its built-in memory to the external server 200 (Step S101).

The external server 200 judges in the user authentication unit 204 whether the received family ID and family password are listed in the user DB 209. When the received data are not listed in the user DB 209, the external server 200 uses the communication control unit 201 to send an “access denied” message to the user terminal 300. On the other hand, when the received family ID and family password are found in the user DB 209, the FQDN (position information of the household server) corresponding to this family ID is extracted from the user DB (Step S103). Then the external server 200 requests the user terminal 300 to send user's user ID and user password (Step S104).

The user inputs his/her user password as requested, and the user terminal 300 sends the user password inputted and the user ID stored in advance in the built-in memory to the external server 200 (Step S105). Upon receiving the user password and the user ID, the external server 200 sends an access request along with the received user ID and user password to the FQDN that is extracted in Step S103 (Step S106).

Receiving the access request, the household server 100 first checks the validity of the access request in the processor 102 (Step S107). As described above, the validity is judged by checking whether or not the IP address of the access source matches the IP address that has been registered in advance. When the access request is found to be invalid, an “access denied” message is sent to the external server 200. The message is forwarded to the user terminal 300 from the external server 200 (Step S109).

On the other hand, when it is judged in Step S107 that the access request is valid, whether or not the received user ID and user password are listed in the user DB 109 is judged in the user authentication unit 103 (Step S108). When the received data are not listed in the user DB 109, an “access denied” message is sent to the external server 200. The message is forwarded to the user terminal 300 from the external server 200 (Step S109). On the other hand, when the received user ID and user password are found in the user DB 109, a message is sent to the external server 200 saying that permission to control is given to the user (Step S110).

Receiving the “control permitted” message from the household server 100, the external server 200 sends to the user terminal 300 a message that prompts the user to input a control instruction (Step S111). The message may be a voice message or e-mail, or may take any other form that suites the user terminal 300. The message sent is outputted in the form of voice, image, or the like in the user terminal 300 (Step S112).

Prompted by the message, the user inputs a desired control instruction, which is sent to the external server 200. The control instruction inputted may be an audio (voice) instruction or e-mail, or may take any other form that suites the user terminal 300. The control instruction is received by the communication control unit 201 of the external server 200, and then sent to the user IF unit 205. The user IF unit 205 converts the received control instruction into text data and sends the text data to the intellectual processing unit 203. When the received control instruction is audio (voice) information, the user IF unit 205 recognizes voice for conversion into text data, which is sent to the intellectual processing unit 203. When the received control instruction is mail data, the user IF unit 205 extracts only the message in the mail and sends the extracted message in the form of text data to the intellectual processing unit 203.

The intellectual processing unit 203 interprets the control instruction from the text data received, and creates control information. Details of this process will be described later. The created control information is sent to the household server 100 (Step S113). The control information sent is registered, along with the family ID and the user ID, in the history DB 208.

The household server 100 creates an execution rule by putting parameters, which are contained in the control information, in a corresponding rule (skeleton rule). Details of this process will be given below. As has been described, the execution rule is created by the execution rule creating unit 104. The created execution rule is registered in the execution rule DB 111 (Step S114), and amessage is sent to the external server 200 saying that the control task is finished (Step S115). The external server 200 forwards the received “control task finished” message to the user terminal 300 (Step S116). The message is displayed on the user terminal 300 (Step S117). Thus completed is control instruction setting processing through the intermediation of the external server 200.

The execution rule registered in Step S114 is implemented by the rule executing unit 105 (Step S118). The rule executing unit 105 monitors the execution rule registered in the execution rule DB 111 to judge whether the condition of the execution rule has been fulfilled or not. When the condition is fulfilled, the device control unit 107 creates a control command, which is sent to the control target client device. After the client device responds to the control command and the control is executed, completion of the action of the execution rule is confirmed. Then the execution rule in question is deleted from the execution rule DB 111.

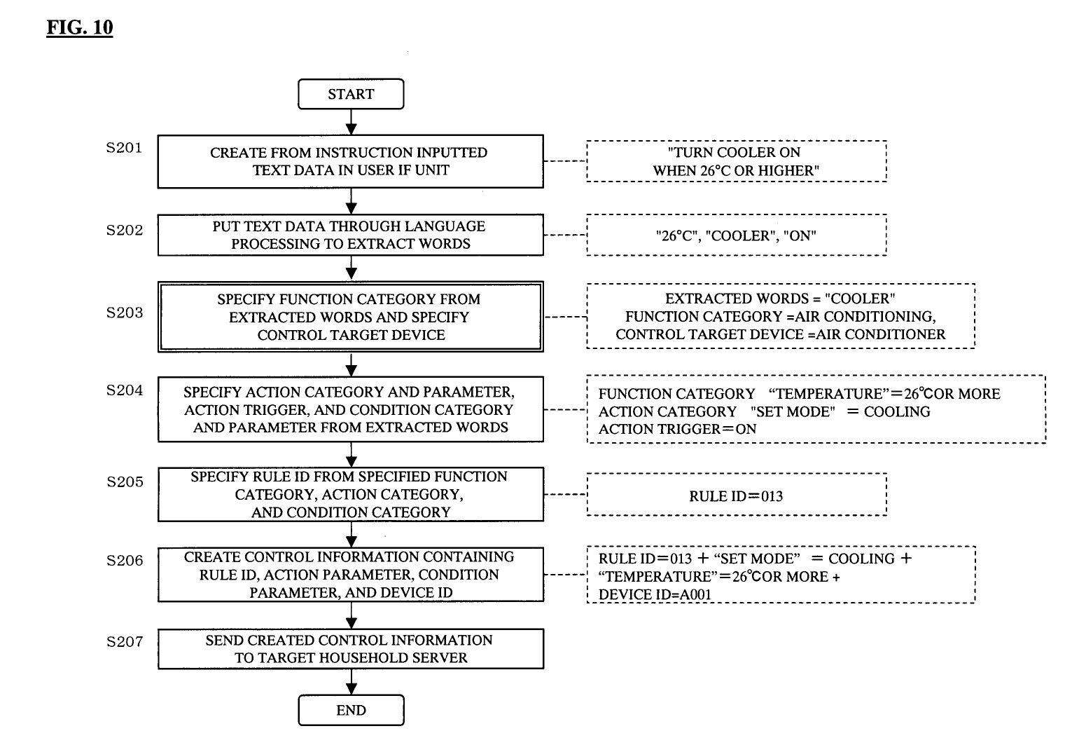

FIG. 10 shows the flow of control information creation processing in the intellectual processing unit 203.

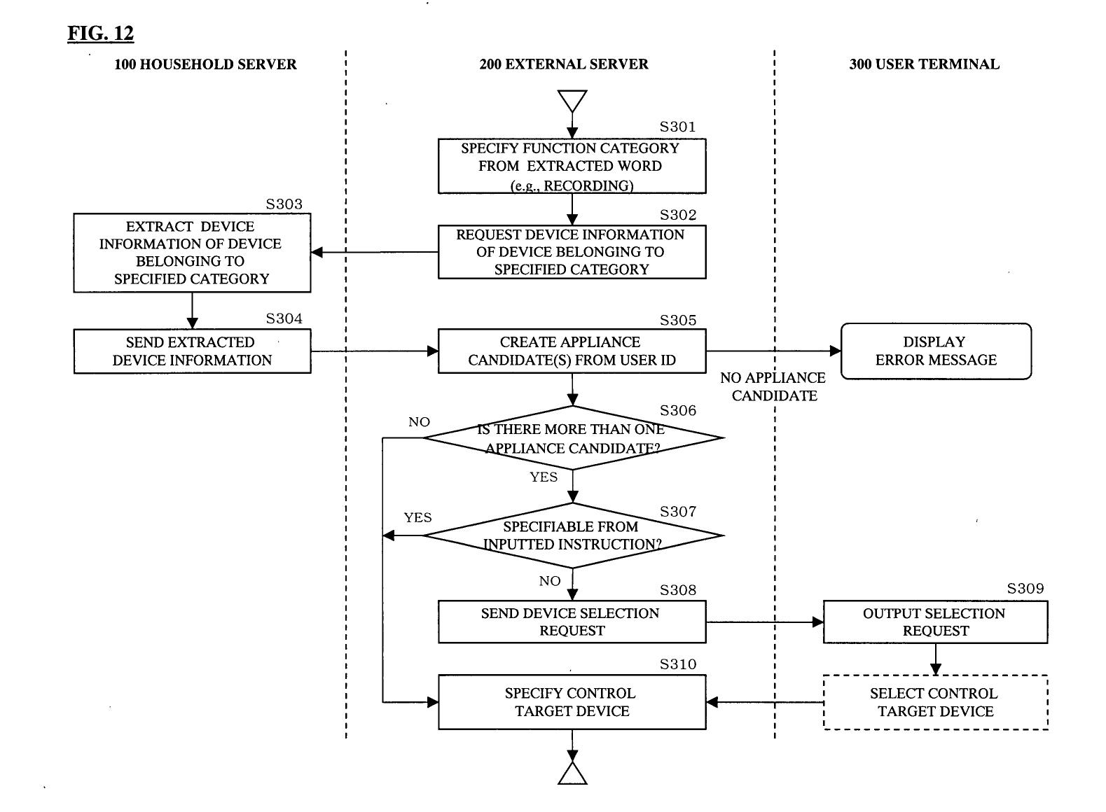

Upon receiving text data from the user IF unit 205 which is obtained from an instruction inputted (Step S201), the intellectual processing unit 203 first puts the text data through language processing to extract words contained in the text (Step S202). For instance, in the case where the text data received says “turn the cooler ON when the temperature reaches 26° C.”, the words “turn”, “cooler”, “ON”, “temperature”, “reach”, and “26° C. ” are extracted from the text data through language processing. The intellectual processing unit 203 next compares the extracted words with keywords of the function category specifying table (see FIG. 6A) in the intellectual DB 206, and specifies the function category of the control target appliance. In the above example, “air conditioning function” is specified as the function category of the control target appliance from the word “cooler”. Then the control target device is specified from the specified function category (Step S203). The device specifying processing will be described in detail below (FIG. 12).

Once the control target device is specified, the intellectual processing unit 203 compares the extracted words with keywords of the control action (action) category specifying table (see FIG. 7A) in the intellectual DB 206, and specifies the control action (action) category and its parameter. In the above example, “set mode” is specified as the action category from the word “cooler” and the parameter is set to “cooling”.

The intellectual processing unit 203 also compares the extracted words with keywords of the trigger specifying table (see FIG. 7B) in the intellectual DB 206, and specifies the trigger of the control action (action). In the above example, “ON” is specified as the trigger from the word “ON”.

Furthermore, the intellectual processing unit 203 compares the extracted words against keywords in the control condition (condition) category specifying table (see FIG. 6B) in the intellectual DB 206, and specifies the control condition (condition) category and its parameter. In the above example, “temperature” is first specified as the condition category from the word “26° C.”. Then, with the set mode being “cooling” and the trigger being “ON” and from the word “26° C.”, an intellectual processing program figures out that the control condition is “26° C. or higher”. The parameter of the condition category “temperature” is thus set to “26° C. or higher” (Step S204).

The intellectual processing unit 203 also compares the function category, action category, and condition category specified in the manner described above with skeleton rules (see FIG. 4A) in the rule DB 207, and specifies a skeleton rule that is consistent with the specified function category, action category, action trigger, and condition category (Step S205). In the above example, the skeleton rule of which rule ID is 013 is picked out of skeleton rules in FIG. 4A as one that is consistent with the function category =air conditioning, the action category=set mode, the action trigger=ON, and the condition category=temperature.

Next, the intellectual processing unit 203 creates control information which contains the rule ID, action parameter, and condition parameter specified in the manner described above as well as the device ID of the control target appliance specified in Step S203 (Step S206). The control information is sent to the household server 100 (Step S207). In the above example, control information containing the rule ID=013, the set mode (action)=cooling, the set temperature (condition)=26° C. or higher, and the device ID=A001 is created and sent to the household server 100. This completes creation of control information and transmission processing of the created control information.

Described above is the flow of the basic processing in creation and transmission of control information. When an inputted instruction per se specifies neither action nor condition, the above processing is incapable of deducing the action category and its parameter in Step S204. For instance, in the case where the name of a broadcast program is inputted as a control instruction, the action category and a few other items cannot be specified solely from the tables of FIGS. 6A and 6B and FIGS. 7A and 7B. In such cases, an auxiliary database (a database of a broadcast program time table or the like) built in the intellectual database is consulted in Step S204 to extract information that enables the intellectual processing program to specify the action category and others. In the above example where a broadcast program name is inputted as a control instruction, the intellectual processing program consults in Step S204 a broadcast program timetable database (the timetables registered by regions), which is an auxiliary database, to extract information concerning the channel, start/finish time, and the like of the program in question, and specifies from the extracted information the action category and its parameter, the action trigger, and the condition category and its parameter.

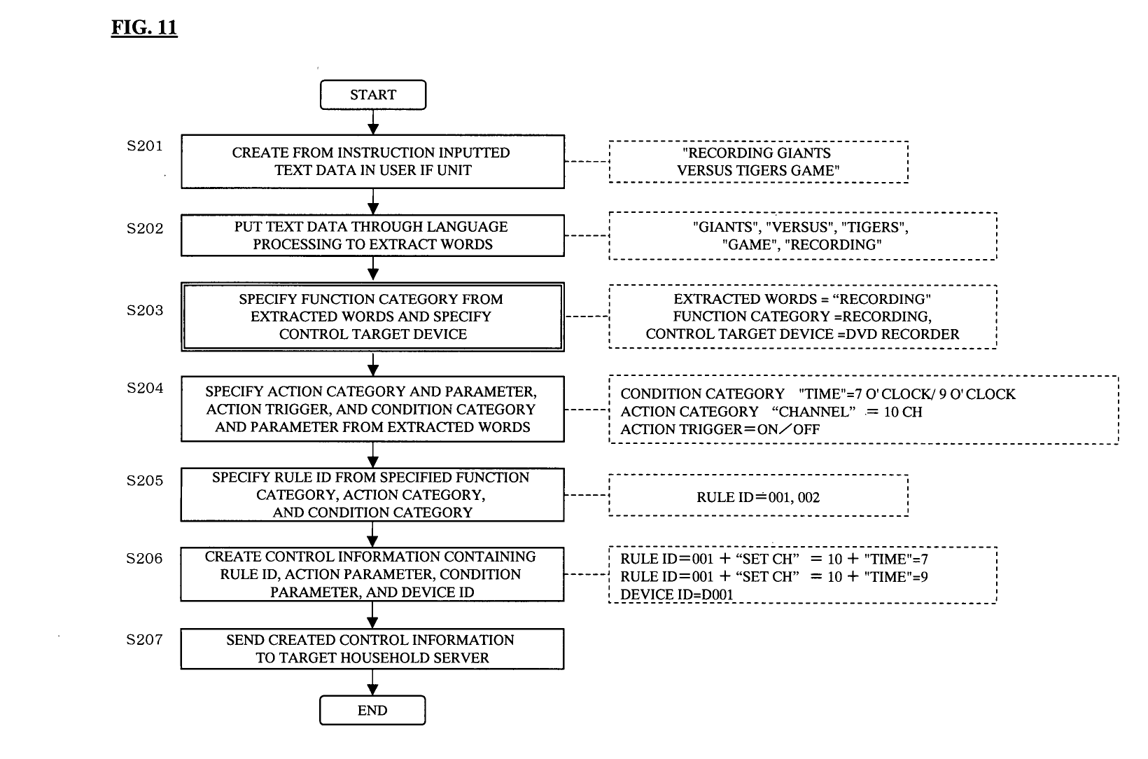

FIG. 11 shows the flow of processing for when an instruction saying “recording the game of Giants versus Tigers” is inputted as a control instruction. Note that the processing of FIG. 11 differs from that of FIG. 10 only in Step S204.

Receiving in Step S201 text data of the instruction saying “recording the game of Giants versus Tigers”, the intellectual processing unit 203 puts the text data through language processing in Step S202 to extract the words “Giants”, “versus”, “Tigers”, “game” and “recording”. Next, the intellectual processing unit 203 specifies in Step S203 a DVD recorder (device ID=D001), for example, as the control target appliance from the word “recording”.

Then the intellectual DB 203 executes in Step S204 the processing of specifying the action category and other items from the words “Giants”, “versus”, “Tigers” and “game”. Unlike the above description with reference to FIG. 10, the broadcast program timetable for the user is consulted to specify a program that agrees with the words “Giants”, “versus”, “Tigers” and “game”. To elaborate, the intellectual processing unit 203 extracts the region code of the user from the user DB 209, and obtains a broadcast program timetable corresponding to this region code from the broadcast program timetable database in the intellectual DB 206. The intellectual processing unit 203 then compares information (the program name, for example) set for each program in the broadcast program timetable with the words “Giants”, “versus”, “Tigers” and “game” to specify a program that these words fit better than any other program in the timetable.

Next, the intellectual processing unit 203 judges from the word “recording” that information necessary for recording has to be extracted from the information set for the program. The information needed to be extracted here is about the start time, the finish time, and the set channel. The intellectual processing unit 203 specifies from the extracted information the action category and others. In this example, the condition category and the condition parameter are specified from information concerning the start time as “time” and “7 o'clock”, respectively, the condition category and the condition parameter are specified from information concerning the finish time as “time” and “9 o'clock”, respectively, and the action category and the action parameter are specified from the information concerning the set channel as “channel” and “10 ch”, respectively. From the word “recording”, the action triggers “ON” and “OFF” are specified for the start time and the finish time, respectively.

As the processing in Step S204 is completed, the intellectual processing unit 203 implements in Step S205 the processing of specifying the rule ID. This processing is identical with the processing in Step S205 of FIG. 10. In this example, two skeleton rules having the rule ID “001” (start recording) and the rule ID “002” (end recording) are specified out of the skeleton rules in FIG. 4A. Thereafter, in Step S206, the intellectual processing unit 203 creates control information which contains the specified rule ID, action parameter, condition parameter, and device ID. In this example, the intellectual processing unit 203 creates two types of control information: one containing the rule ID=001, the “set channel” action category=10 ch, the “time” condition category =7 o'clock, and the device ID=D001, and the other containing the rule ID=002, the “set channel” action category=10 ch, the “time” condition category=9 o'clock, and the device ID=D001. The created control information is sent to the household server 100 in Step S207. This completes the control information creation and transmission processing.

FIG. 12 shows details of the processing of specifying a control target appliance in Step S203.

The intellectual processing unit 203 specifies the function category of the target appliance from the extracted words (Step S301), and then sends to the household server 100 the specified function category and a transmission request for device information (see FIG. 3A) of a device or devices that fall within the specified function category (Step S302). Receiving the request, the household server 100 compares the received function category with device information stored in the device DB 108, and extracts the device information (device ID, device name, location, and user) of this function category (Step S303). In the above example, device information of the “air conditioning” function category is extracted. If there is more than one corresponding device, information of every one of the corresponding devices is extracted. The extracted device information is sent to the external server 200 (Step S304). The device information sent to the external server 200 is received by the communication control unit 201 and forwarded to the intellectual processing unit 203.

Of the devices in the received device information, only those that are associated with the user ID of the user who has inputted the control instruction are set as device candidates by the intellectual processing unit 203 (Step S305). If there is no device candidate at this point, an error message is sent from the communication control unit 201 to the user terminal 300. In the case where there is any device candidate, the intellectual processing unit 203 judges whether or not there are plural device candidates (Step S306). When only one device candidate is found as a result, this device is specified as the control target appliance (Step S310).

On the other hand, when more than one device candidate is found, the intellectual processing unit 203 judges whether or not it is possible to specify the control target appliance from the instruction inputted by the user (the words extracted in Step S202) (Step S307). For instance, if the instruction inputted contains a word that specifies the location of the control target appliance (if this is the case, the word has been extracted in Step S202), the word is compared against the location table in the intellectual DB 206 to specify the location of the appliance. Furthermore, this location is compared with locations of the device candidates to judge whether or not a device of the corresponding location is included in the device candidates. When there is only one device that is located in this location, the process proceeds to Step S307 and specifies this device as the control target appliance. On the other hand, when there is more than one device candidate that is located in the location, a selection request is sent to the user terminal 300 with those device candidates presented as options (Step S308).

In the case where the instruction inputted by the user does not contain words that can be utilized to specify one control target appliance by location or any other way, the process proceeds from Step S307 toward the direction indicated by a NO arrow, and the intellectual processing unit 203 makes a selection request to the user terminal 300 presenting as options the appliance candidates that are created in Step S305 (Step S308). For instance, when the control instruction inputted is “turn the cooler ON when the temperature reaches 26° C.”, the instruction include no words that can be utilized to specify the control target appliance (location-related words). Accordingly, a selection request is sent to the user terminal 300 with the device candidates created in Step S305 (air conditioners whose function category is “air conditioning” and whose user ID is “All” or of this user) as options.

Receiving the selection request, the user terminal 300 presents the options to the user and prompts the user to specify the control target appliance (Step S309). The user selects a desired device upon the request and the selection information is sent to the external server 200. The intellectual processing unit 203 specifies the chosen device as the control target appliance (Step S310). The processing of specifying the control target appliance is thus completed.

<<Embodiment 2>>

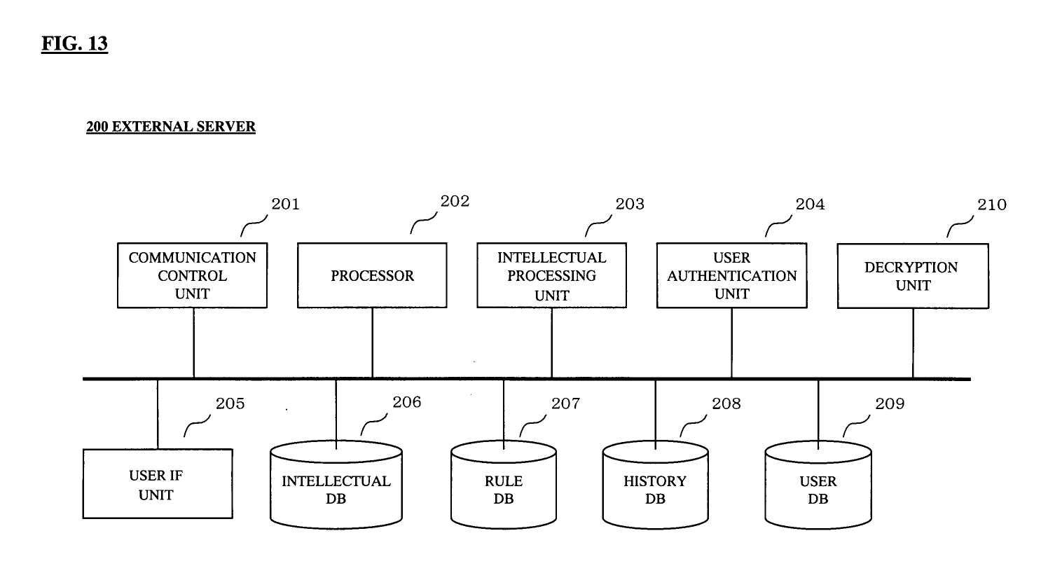

Described next is Embodiment 2, which is a partial modification of the above Embodiment 1. This embodiment uses encrypted FQDN as family ID. As shown in FIG. 13, the external server 200 has a decryption unit 210 for decrypting the family ID (encrypted FQDN) received from the user terminal 300. The user DB 209 stores encrypted FQDN as family ID in FIG. 8. Of the data shown in FIG. 8, household server position information (FQDN) is excluded from subjects to store since the information is obtained by decrypting the encrypting family ID. In other words, household server position information (FQDN) is not stored in the user DB 209 of FIG. 13. This embodiment is therefore reduced in data amount of the user DB 209 compared to Embodiment 1. The rest of this embodiment is identical with Embodiment 1 (FIG. 5).

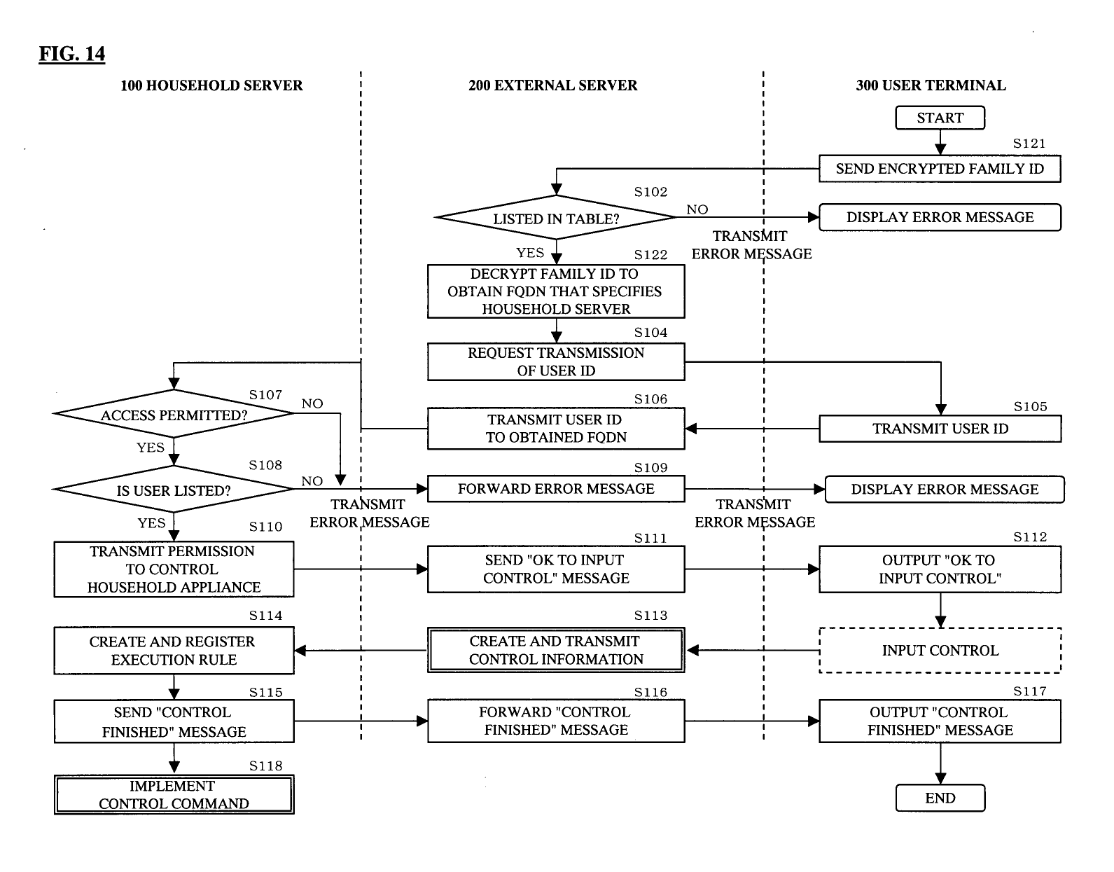

FIG. 14 shows a processing flow of this embodiment. This processing flow differs from FIG. 9 in Steps S121 and S122. The rest is identical with FIG. 9.

The first step in this processing flow is Step S121 where the family ID (encrypted FQDN) and the family password are sent from the user terminal 300 to the external server 200. The external server judges in Step S102 whether the received family ID and password are listed in the user DB 209. When the received ID and password are not found in the database, an error message is sent to the user terminal whereas processing of obtaining FQDN is implemented in Step S122 when they are found in the database. The processing of obtaining FQDN is performed by the decryption unit 210 as described above. The family ID received from the user terminal 300 is forwarded to the decryption unit 210, and is decrypted in accordance with a pre-set encrypting rule to obtain the FQDN of the household server 100 used by the user.

As the FQDN of the household server 100 is thus obtained, the external server 200 requests the user terminal 300 to send a user ID (Step S104). Upon receiving the transmission request, the user terminal 300 sends the user ID and user password to the external server 200 (Step S105). The external server 200 sends the received user ID and user password to the FQDN that has been obtained in Step S122 (Step S106). The household server 100 checks the access right of the external server 200 and the access right of the user in Steps S107 and S108, respectively. The subsequent processing is identical with those in Embodiment 1 (Steps S109 through S118). In this way, remote control while away from home is accomplished.

<<Embodiment 3>>

Described next is Embodiment 3, which is a partial modification of the above Embodiment 1. In this embodiment, upon the initial access from the user terminal 300, the external server 200 is provided with an ID package composed of user's family ID, family password, user ID, and user password. Note that the external server 200 in this embodiment is structured the same way as in Embodiment 1 (FIG. 5). However, the processor 202 in this embodiment has a function of breaking the ID package received from the external server down into the family ID, the family password, the user ID, and the user password in addition to the functions described above.

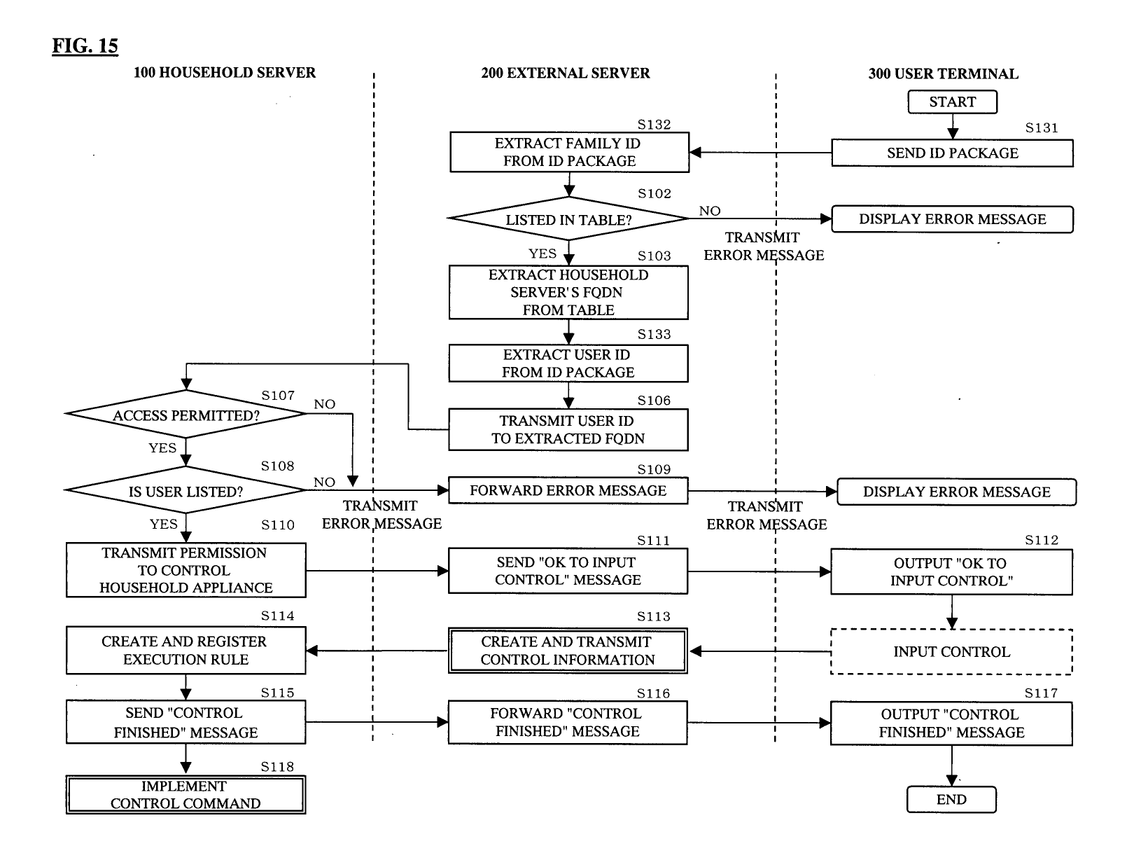

FIG. 15 shows a processing flow of this embodiment. This processing flow differs from FIG. 9 in Steps S131, S132 and S133. The rest of the processing is identical with FIG. 9.

The first step of this processing flow is Step S131, where the ID package is sent from the user terminal 300 to the external server 200. The external server 200 extracts in Step S132 the family ID and the family password from the received ID package to judge whether the extracted family ID and family password are listed in the user DB 209 (Step S102). If the received ID and password are not found in the user DB 209, an error message is sent to the user terminal. When the received ID and password are found in the database, processing is implemented to obtain from the user DB 209 the FQDN of the household server used by the user in Step S133 (Step S103).

As the FQDN of the household server 100 is obtained, the external server 200 executes the processing of extracting the user ID and the user password from the ID package (Step S133). The obtained user ID and user password are sent to the FQDN that has been obtained in Step S103 (Step S106). The household server 100 checks the access right of the external server 200 and the access right of the user in Steps S107 and S108, respectively. The subsequent processing is identical with those in Embodiment 1 (Steps S109 through S118). In this way, remote control while away from home is accomplished.

Several embodiments of the present invention have been described in the above. Needless to say, the present invention is not limited to those embodiments and various other modifications are possible.

For instance, user ID and a control instruction, which are inputted as audio (voice) information or mail information in the above embodiments, may be inputted through a homepage provided to the user terminal 300.

Specifically, the external server 200 prepares a homepage corresponding to each household server 100, and the URL of the homepage is used as family ID. In this case, a Web server function for providing a WWW (World Wide Web) service is added to the functions of the external server 200, and the Web server is set such that access from a user terminal to the homepage is transferred as access to the household server 100. The user terminal 300 provides the URL of the allotted homepage as family ID to the external server 200, which first checks the URL. When the URL is found to be valid, the homepage corresponding to the URL is provided to the user terminal 300 and a user ID input page is opened.

Following instructions on the homepage, the user inputs his/her user ID and user password, which are presented from the external server 200 to the household server 100. When the ID and password are valid, input of a control instruction is accepted and a message to that effect is displayed on the page. The user follows the instructions on the page and operates the user terminal to have a control information input page displayed on the terminal display. As the user inputs a control instruction, the control instruction is sent to the external server 200. Subsequently, control information is created in the manner described in the above embodiments. The control information created is sent from the external server 200 to the household server 100, and control of the target appliance is implemented.

Instead of confirming the validity of a user from his/her family ID, user ID, family password, and user password as in the above embodiments, a security token which proves that one is authorized to have the family ID and user ID in question may be presented along with the family ID and user ID. A security token as such can take various forms depending on authentication algorithm. For instance, in basic authentication RFC2617, which is widely used for user authentication on Web servers, a base64-encoded password can serve as a security token, an X. 509 format certificate in user authentication that is based on PKI (Public Key Infrastructure), and physical information such as fingerprint and voice pattern in user authentication that is based on biometrics. When employing authentication by a security token, encrypted communication paths such as SSL (Secure Socket Layer) and IPsec are set between the user terminal 300 and the external server 200 and between the external server 200 and the household server 100 in order to protect a security token against theft. By prohibiting the household server from establishing an encrypted communication path with other servers than specified, only access from an authorized external server is allowed as in the above embodiments where IP address is used for authentication.

Various other modifications on the mode of carrying out the present invention are possible without departing from the technical concept disclosed in the scope of the claims appended below.

1. A network system, comprising:
a first server for controlling appliances in a household; and
a second server allowed to access the first server, the first server comprising:
a first authentication means for authenticating an access source; and
appliance controlling means for controlling a control target appliance in accordance with control information received from the second server,
the second server comprising:
a second authentication means for authenticating the access source;
access target specifying means for specifying which first server is to be used by a user as the access source;
access request means for sending an access request to the specified first server;
control information creating means for creating control information based on a control instruction which is received from a user terminal; and
transmission means for sending the created control information to the first server that is the access target.

2. A network system according to claim 1, wherein the first authentication means authenticate an access source by checking whether or not position information of the access source matches position information that has been registered in advance.

3. A network system according to claim 1, wherein the first authentication means has a first user database for registering users that can control appliances in the household, and authenticates an access source by checking whether or not first user identification information sent from the access source is listed in the first user database.

4. A network system according to any one of claims 1 to 3,
wherein the appliance controlling means has a rule database for storing stylized rule patterns, which regulate rules in controlling the appliances, and
wherein the appliance controlling means specifies at least one of rule patterns in the rule database that is consistent with rule pattern specifying information, which is contained in control information received from the second server, and controls a control target appliance in accordance with the specified rule pattern.

5. A network system according to any one of claims 1 to 3,
wherein the second server further includes a second user database in which user identification information is stored and associated with position information of the first server that is to be used by the user,
wherein the second authentication means authenticates an access source by checking whether or not second user identification information received from the user terminal is listed in the second user database, and
wherein the access target specifying means extracts, from the second user database, position information of the first server that is associated with the second user identification information received from the user terminal.

6. A network system according to any one of claims 1 to 3,
wherein the second server further includes a second user database for storing encrypted user identification information, which is obtained by encrypting position information of the first server that is to be used by the user,
wherein the second authentication means authenticates an access source by checking whether or not encrypted second user identification information, which is received from the user terminal, is listed in the second user database, and
wherein the access target specifying means has means for decrypting the second user identification information received from the user terminal and obtaining, from the decrypted information, position information of the first server that is to be used by the user.

7. A network system according to any one of claims 1 to 3,
wherein the control information creating means has a rule database for storing stylized rule patterns, which regulate rules in controlling the appliances, and
wherein the control information creating means specifies at least one of rule patterns in the rule database that is consistent with a control instruction received from the user terminal, and creates control information that includes information for specifying the rule pattern.

8. An appliance controlling household server for controlling control target appliances in a household upon receiving control information from an intermediary server that mediates a control instruction from a user terminal, comprising:
access source authentication means for authenticating an access source; and
appliance controlling means for controlling a control target appliance in accordance with control information received from the intermediary server,
wherein the access source authentication means authenticates the access source by checking whether or not position information of the access source matches position information that has been registered in advance.

9. An appliance controlling household server according to claim 8, wherein the access source authentication means has a user database for registering users that can control appliances in the household, and authenticates the access source by checking whether or not user identification information sent from the access source is listed in the user database.

10. An appliance controlling household server according to claim 8 or 9,
wherein the appliance controlling means has a rule database for storing stylized rule patterns, which regulate rules in controlling the appliances, and
wherein the appliance controlling means specifies at least one of rule patterns in the rule database that is consistent with rule pattern specifying information, which is contained in control information received from the intermediary server, and controls a control target appliance in accordance with the specified rule pattern.

11. An intermediary server for sending, to an appliance controlling household server, control information corresponding to a control instruction received from a user terminal, comprising:
access source authentication means for authenticating an access source;
access target specifying means for specifying which appliance controlling household server is to be used by a user as the access source;
access request means for sending an access request to the specified appliance controlling household server;
control information creating means for creating the control information based on the control instruction which is received from the user terminal; and
transmission means for sending the created control information to the appliance controlling household server that is the access target.

12. An intermediary server according to claim 11, further comprising a user database in which user identification information for identifying a user is stored and associated with position information of the appliance controlling household server that is to be used by the user,
wherein the access source authentication means authenticates the access source by checking whether or not the user identification information received from the user terminal is listed in the user database, and
wherein the access target specifying means extracts, from the user database, position information of the appliance controlling household server that is associated with the user identification information received from the user terminal.

13. An intermediary server according to claim 11, further comprising a user database for storing encrypted user identification information, which is obtained by encrypting position information of the appliance controlling household server that is to be used by the user,
wherein the access source authentication means authenticates the access source by checking whether or not encrypted user identification information, which is received from the user terminal, is listed in the user database, and
wherein the access target specifying means has means for decrypting the user identification information received from the user terminal and obtaining, from the decrypted information, position information of the appliance controlling household server that is to be used by the user.

14. An intermediary server according to any one of claim 11 to 13,
wherein the control information creating means has a rule database for storing stylized rule patterns, which regulate rules in controlling appliances, and
wherein the control information creating means specifies at least one of rule patterns in the rule database that is consistent with a control instruction received from the user terminal, and creates control information that includes information for specifying the rule pattern.
